(19) United States
(12) Patent Application Publication
(10) Pub. No.: US 2017/0175577 A1
(43) Pub. Date: Jun. 22, 2017

(54) SYSTEMS AND METHODS FOR INCREASING HEAT TRANSFER USING AT LEAST ONE BAFFLE IN AN IMPINGEMENT CHAMBER OF A NOZZLE IN A TURBINE

(71) Applicant: General Electric Company, Schenectady, NY (US)

(72) Inventor: Sandip Dutta, Greenville, SC (US)

(73) Assignee: General Electric Company, Schenectady, NY (US)

(21) Appl. No.: 14/974,460

(22) Filed: Dec. 18, 2015

(51) Int. Cl. F01D 25/12; F01D 9/02; F02C 3/04

(52) U.S. Cl. CPC F01D 25/12; F02C 3/04; F01D 9/02; F05D 2220/32; F05D 2240/128; F05D 2260/22141; F05D 2260/201

(57) ABSTRACT

A nozzle for a turbine is disclosed. The nozzle includes a shell, an orifice plate disposed adjacent to the shell, an impingement chamber formed between the shell and the orifice plate, and at least one baffle extending from the orifice plate into the impingement chamber to push a flow of cooling fluid into the shell.

### FIELD

Embodiments of the disclosure relate generally to gas turbine engines and more particularly relate to systems and methods for increasing heat transfer using at least one baffle in an impingement chamber of a nozzle in a turbine.

### BACKGROUND

Surfaces within a nozzle of a turbine may include a number of bumps to increase the surface area of the nozzle for increased heat transfer. The bumped surface of the nozzle may have an increased flow resistance as compared to a smooth surface. In this manner, a flow of cooling fluid may tend to avoid the bumped surface.

### BRIEF DESCRIPTION

Some or all of the above needs and/or problems may be addressed by certain embodiments of the disclosure. According to one embodiment, there is disclosed a nozzle for a turbine. The nozzle may include a shell, an orifice plate disposed adjacent to the shell, an impingement chamber formed between the shell and the orifice plate, and at least one baffle extending from the orifice plate into the impingement chamber to push a flow of cooling fluid into the shell.

According to another embodiment, there is disclosed a nozzle for a turbine. The nozzle may include a shell having an outer surface and an inner surface, a number of bumps formed on the inner surface of the shell, and an orifice plate having an inner surface and an outer surface. The orifice plate may be disposed within the shell. The nozzle also may include an impingement chamber formed between the shell and the orifice plate and at least one baffle extending from the outer surface of the orifice plate into the impingement chamber.

Further, according to another embodiment, there is disclosed a gas turbine engine. The gas turbine engine may include a compressor, a combustor, and a turbine. The turbine may include a nozzle. The nozzle may include a shell having an outer surface and an inner surface, a number of bumps formed on the inner surface of the shell, and an orifice plate having an inner surface and an outer surface. The orifice plate may be disposed within the shell. The nozzle also may include an impingement chamber formed between the shell and the orifice plate and at least one baffle extending from the outer surface of the orifice plate into the impingement chamber. The at least one baffle may push a flow of cooling fluid into the number of bumps formed on the inner surface of the shell.

Other embodiments, aspects, and features of the disclosure will become apparent to those skilled in the art from the following detailed description, the accompanying drawings, and the appended claims.

### BRIEF DESCRIPTION OF THE DRAWINGS

Reference will now be made to the accompanying drawings, which are not necessarily drawn to scale.

FIG. 1 schematically depicts an example view of a gas turbine engine according to an embodiment of the disclosure.

FIG. 2 schematically depicts a cross-section of an example nozzle according to an embodiment of the disclosure.

FIG. 3 schematically depicts a portion of an example nozzle according to an embodiment of the disclosure.

FIG. 4 schematically depicts a portion of an example nozzle according to an embodiment of the disclosure.

FIG. 5 schematically depicts a portion of an example nozzle according to an embodiment of the disclosure.

FIG. 6 schematically depicts a portion of an example nozzle according to an embodiment of the disclosure.

FIGS. 7A-7H schematically depict various portions of an example nozzle according to certain embodiments of the disclosure.

### DETAILED DESCRIPTION

Illustrative embodiments will now be described more fully hereinafter with reference to the accompanying drawings, in which some, but not all embodiments are shown. The disclosure may be embodied in many different forms and should not be construed as limited to the embodiments set forth herein. Like numbers refer to like elements throughout.

Illustrative embodiments of the disclosure are directed to, among other things, systems and methods for increasing heat transfer using at least one baffle in an impingement chamber of a nozzle in a turbine. For example, in some instances, a turbine nozzle (such as a stator, a guide vane, or the like) may include a flow of cooling fluid therein. In some instances, the flow of cooling fluid may be air. Any coolant may be used.

The nozzle may include a shell, an orifice plate disposed adjacent to the shell, an impingement chamber formed between the shell and the orifice plate, and at least one baffle extending from the orifice plate into the impingement chamber to push the flow of cooling fluid into the shell. For example, in some instances, a number of bumps may be formed on a surface of the shell. The bumped surface of the shell may have an increased flow resistance as compared to a smooth surface. In this manner, the flow of cooling fluid may tend to avoid the bumped (i.e., rough) surface. In order to force the flow of cooling fluid into and through the bumped surface of the shell, the at least one baffle may extend from the orifice plate into the impingement chamber to push the flow of cooling fluid entering the impingement chamber into the bumped surface of the shell, thereby increasing the heat transfer within the nozzle, reducing the cooling flow requirements, and increasing engine efficiency.

The orifice plate may include a number of orifices through the orifice plate, and the at least one baffle may be positioned adjacent to at least one of the orifices. In some instances, the at least one baffle may include a number of baffles. For example, a number of baffles may extend from the orifice plate adjacent to the orifices.

In some instances, the nozzle may include a cavity therein with the orifice plate disposed within the cavity. The flow of cooling fluid may flow from the cavity, through the orifices in the orifice plate, and into the impingement chamber, where at least one baffle may force the flow of cooling fluid into the inter-bump surface of the shell. In other instances, the nozzle may include a number of cavities and a number of orifice plates, such as the nozzle disclosed in U.S. Pat. No. 9,151,173, which is herein incorporated by reference in its entirely.

The at least one baffle may be any suitable structure capable of forcing the flow of cooling fluid into and through the bumped surface of the shell. For example, at least one baffle may include a triangular protrusion, a V-shaped protrusion, a circular protrusion, a flow obstruction, or a combinations thereof.

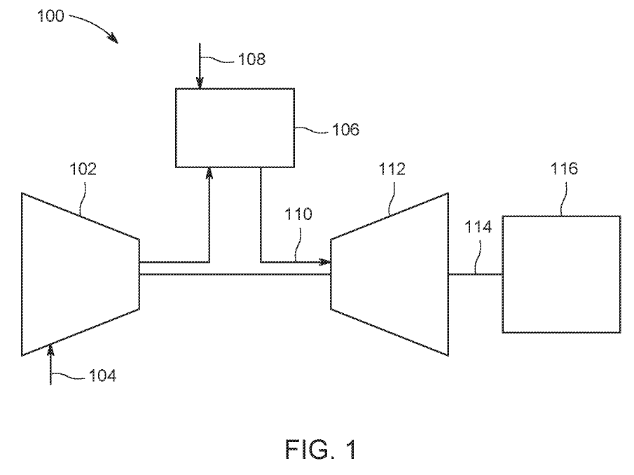

Turning now to the drawings, FIG. 1 shows a schematic view of gas turbine engine 100 as may be used herein. The gas turbine engine 100 may include a compressor 102. The compressor 102 compresses an incoming flow of air 104. The compressor 102 delivers the compressed flow of air 104 to a combustor 106. The combustor 106 mixes the compressed flow of air 104 with a compressed flow of fuel 108 and ignites the mixture to create a flow of combustion gases 110. Although only a single combustor 106 is shown, the gas turbine engine 100 may include any number of combustors 106. The flow of combustion gases 110 is in turn delivered to a downstream turbine 112. The flow of combustion gases 110 drives the turbine 112 to produce mechanical work. The mechanical work produced in the turbine 112 drives the compressor 102 via a shaft 114 and an external load 116, such as an electrical generator or the like.

The gas turbine engine 100 may use natural gas, various types of syngas, and/or other types of fuels. The gas turbine engine 100 may be anyone of a number of different gas turbine engines such as those offered by General Electric Company of Schenectady, New York and the like. The gas turbine engine 100 may have different configurations and may use other types of components. Other types of gas turbine engines also may be used herein. Multiple gas turbine engines, other types of turbines, and other types of power generation equipment also may be used herein together.

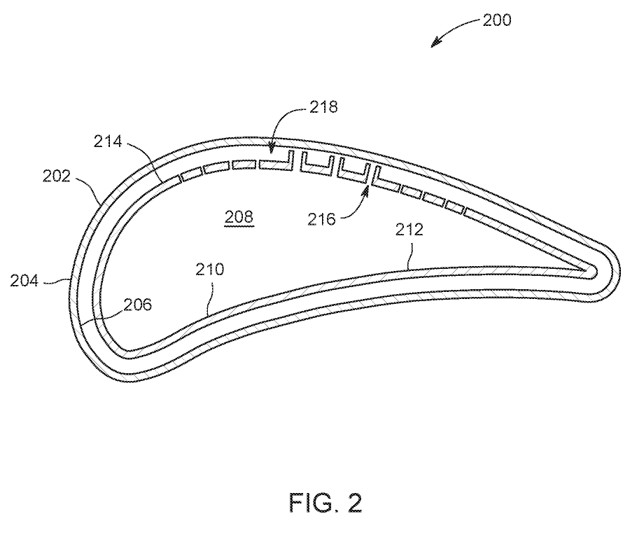

FIG. 2 schematically depicts a cross-section of one example embodiment of a nozzle 200 that may be used in the turbine 112 of FIG. 1. The nozzle 200 may include a shell 202 having an outer surface 204, an inner surface 206, and a cavity 208. An orifice plate 210 may be disposed within the cavity 208 of the shell 202. The orifice plate 202 may include an inner surface 212, an outer surface 214, and a number of orifices 216. The inner surface 206 of the shell 202 and the outer surface 214 of the orifice plate 210 may form an impingement chamber 218 there in between. A flow of cooling fluid may flow from the cavity 208, through the orifices 216 in the orifice plate 210, and into the impingement chamber 218.

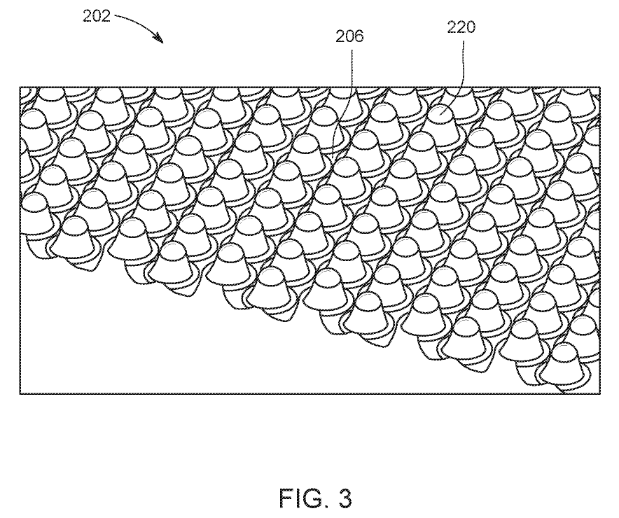

In some instances, as depicted in FIG. 3, the inner surface 206 of the shell 202 may include a number of bumps 220. Any rough or texturized surface may be used. The bumps 220 on the inner surface 206 of the shell 202 may increase the surface area of the inner surface 206 of the shell 202 for heat transfer purposes. The bumps 220 on the inner surface 206 of the shell 202 may have an increased flow resistance as compared to a smooth surface. In this manner, the flow of cooling fluid may tend to avoid the bumps 220 on the inner surface 206 of the shell 202.

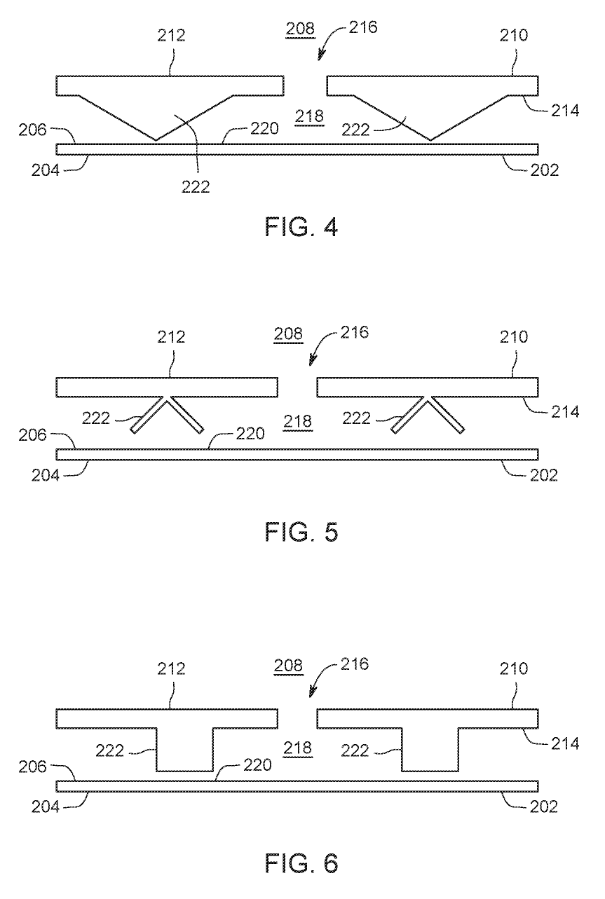

As depicted in FIG. 4, in order to force the flow of cooling fluid into and through the bumps 220 on the inner surface 206 of the shell 202, at least one baffle 222 may extend from the outer surface 214 of the orifice plate 210 into the impingement chamber 218 to push the flow of cooling fluid entering the impingement chamber 218 into the bumps 220 on the inner surface 206 of the shell 202. In some instances, a number of baffles 222 may be used. The baffles 222 may be integral with the orifice plate 210. The baffles 222 may be positioned adjacent to the orifices 216.

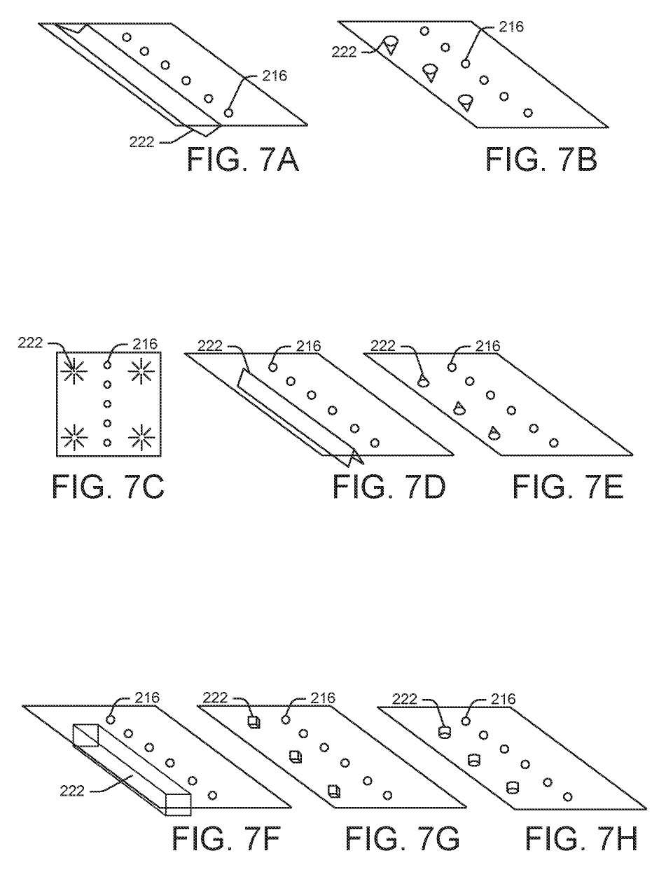

The baffles 222 may be any suitable structure capable of forcing the flow of cooling fluid into and through the bumps 220 on the inner surface 206 of the shell 202. The baffles 222 may include three dimensional or two dimensional profiles. For example, the baffles 222 in FIG. 4 may include two dimensional ridges with triangular cross sections or three dimensional cone shaped protrusions. FIGS. 5 and 6 depict alternative baffle 222 designs. For example, the baffles 222 in FIG. 5 are inverted V-shaped protrusion, which can be hollow cones or broom like structure made out of wire-like protrusions. The baffles 222 in FIG. 6 may be circular and/or rectangular blocks. The baffles 222 is FIGS. 4, 5 and 6 can be continuous ridges. The baffles 222 disclosed herein are but a few of many. For example, FIGS. 7A-7H depicts various baffle 222 designs, including, but not limited to, elongated triangular ridges, cones, broom-like structures, V-shaped ridges, inverted hanging cones, an elongated rectangular block, square protrusions, circular protrusions, or combinations thereof. Any protrusion or flow obstruction may be used herein.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments.

That which is claimed:

1. A turbine nozzle with a flow of cooling fluid therein, comprising:
a shell;
an orifice plate disposed adjacent to the shell;
an impingement chamber formed between the shell and the orifice plate; and
at least one baffle extending from the orifice plate into the impingement chamber to push the flow of cooling fluid into the shell.

2. The nozzle of claim 1, further comprising a plurality of bumps formed on a surface of the shell.

3. The nozzle of claim 1, further comprising a plurality of orifices through the orifice plate.

4. The nozzle of claim 3, wherein the at least one baffle is positioned adjacent to at least one of the plurality of orifices.

5. The nozzle of claim 1, wherein the at least one baffle comprises a plurality of baffles.

6. The nozzle of claim 1, further comprising at least one cavity within the shell.

7. The nozzle of claim 1, wherein the at least one baffle comprises a triangular protrusion, a V-shaped protrusion, a circular protrusion, or a combinations thereof

8. A nozzle for a turbine, comprising:
a shell comprising an outer surface and an inner surface;
a plurality of bumps formed on the inner surface of the shell;
an orifice plate comprising an inner surface and an outer surface, wherein the orifice plate is disposed within the shell;
an impingement chamber formed between the shell and the orifice plate; and
at least one baffle extending from the outer surface of the orifice plate into the impingement chamber.

9. The nozzle of claim 8, wherein the at least one baffle pushes a flow of cooling fluid into the plurality of bumps formed on the inner surface of the shell.

10. The nozzle of claim 8, further comprising a plurality of orifices through the orifice plate.

11. The nozzle of claim 10, wherein the at least one baffle is positioned adjacent to at least one of the plurality of orifices.

12. The nozzle of claim 8, wherein the at least one baffle comprises a plurality of baffles.

13. The nozzle of claim 8, further comprising at least one cavity within the shell.

14. The nozzle of claim 8, wherein the at least one baffle comprises a triangular protrusion, a conical or inverted cone protrusion, a V-shaped protrusion, a circular protrusion, or a combinations thereof.

15. A gas turbine engine, comprising:
a compressor, a combustor, and a turbine comprising a nozzle, the nozzle comprising:
a shell comprising an outer surface and an inner surface;
a plurality of bumps formed on the inner surface of the shell;
an orifice plate comprising an inner surface and an outer surface, wherein the orifice plate is disposed within the shell;
an impingement chamber formed between the shell and the orifice plate; and
at least one baffle extending from the outer surface of the orifice plate into the impingement chamber, wherein the at least one baffle pushes a flow of cooling fluid into the plurality of bumps formed on the inner surface of the shell.

16. The gas turbine engine of claim 15, further comprising a plurality of orifices through the orifice plate.

17. The gas turbine engine of claim 16, wherein the at least one baffle is positioned adjacent to at least one of the plurality of orifices.

18. The gas turbine engine of claim 15, wherein the at least one baffle comprises a plurality of baffles.

19. The gas turbine engine of claim 15, further comprising at least one cavity within the shell.

20. The gas turbine engine of claim 15, wherein the at least one baffle comprises a triangular protrusion, a V-shaped protrusion, a circular protrusion, or a combinations thereof.
